(19) United States
(12) Patent Application Publication
(10) Pub. No.: US 2013/0257736 A1
(43) Pub. Date: Oct. 3, 2013

(54) GESTURE SENSING APPARATUS, ELECTRONIC SYSTEM HAVING GESTURE INPUT FUNCTION, AND GESTURE DETERMINING METHOD

(71) Applicants: Chia-Chang Hou, New Taipei City (TW); Chun-Chieh Li, New Taipei City (TW); Chia-Te Chou, New Taipei City (TW); Shou-Te Wei, New Taipei City (TW); Ruey-Jiann Lin, New Taipei City (TW)

(72) Inventors: Chia-Chang Hou, New Taipei City (TW); Chun-Chieh Li, New Taipei City (TW); Chia-Te Chou, New Taipei City (TW); Shou-Te Wei, New Taipei City (TW); Ruey-Jiann Lin, New Taipei City (TW)

(73) Assignee: WISTRON CORPORATION, New Taipei City (TW)

(21) Appl. No.: 13/548,217

(22) Filed: Jul. 13, 2012

(30) Foreign Application Priority Data
Apr. 3, 2012 (TW) 101111860

(51) Int. Cl. G06F 3/01; G06F 3/02

(52) U.S. Cl. 345/168; 345/156

(57) ABSTRACT

A gesture sensing apparatus configured to be disposed on an electronic apparatus is provided. The gesture sensing apparatus includes at least one optical unit set disposed beside a surface of the electronic apparatus and defining a virtual plane. Each of the optical unit set includes a plurality of optical units, and each of the optical units includes a light source and an image capturing device. The light source emits a detecting light towards the virtual plane. The virtual plane extends from the surface toward a direction away from the surface. The image capturing device captures an image along the virtual plane. When an object intersects the virtual plane, the object reflects the detecting light in the virtual plane into a reflected light. The image capturing device detects the reflected light to obtain information of the object. An electronic system having a gesture input function is also provided.

### CROSS-REFERENCE TO RELATED APPLICATION

This application claims the priority benefit of Taiwan application serial no. 101111860, filed on Apr. 3, 2012. The entirety of the above-mentioned patent application is hereby incorporated by reference herein and made a part of this specification.

### BACKGROUND OF THE INVENTION

1. Field of the Invention

The invention relates to a sensing apparatus and particularly relates to a gesture sensing apparatus.

2. Description of Related Art

The conventional user interface usually utilizes keys, keyboard, or mouse to control an electronic apparatus. As technology advances, new user interfaces are becoming more and more user-friendly and convenient. The touch control interface is one of the successful examples, which allows the user to intuitionally touch and select the items on the screen to control the apparatus.

However, the touch control interface still requires the user to touch the screen with fingers or a stylus, so as to control the apparatus, and the methods for achieving touch control are still limited to the following types: single-point touch control, multiple-point touch control, dragging, etc. In addition, touch control requires the user to touch the screen with his fingers, which also limits the applicability of touch control. For example, when a housewife is cooking, if she touches the screen with her greasy hands to display recipes, the screen may be greased as well, which is inconvenient. In addition, when the surgeon is wearing sterile gloves and performing an operation, it is inconvenient for him/her to touch the screen to look up image data of patient because the gloves may be contaminated. Or, when the mechanist is repairing a machine, it is inconvenient for the mechanist to touch the screen to display maintenance manual because his/her hands may be dirty. Moreover, when the user is watching television in the bathtub, touching the screen with wet hands may cause bad influence to the television.

By contrast, the operation of a gesture sensing apparatus allows the user to perform control by posing the user's hands or other objects spatially in a certain way, so as to control without touching the screen. The conventional gesture sensing apparatus usually uses a three-dimensional camera to sense the gesture in space, but the three-dimensional camera and the processor for processing three-dimensional images are usually expensive. As a result, the costs for producing the conventional gesture sensing apparatuses are high and the conventional gesture sensing apparatuses are not widely applied.

### SUMMARY OF THE INVENTION

The invention provides a gesture sensing apparatus, which achieves efficient gesture sensing with low costs.

According to an embodiment of the invention, a gesture sensing apparatus is provided, which is configured to be disposed on an electronic apparatus. The gesture sensing apparatus includes at least an optical unit set that is disposed beside a surface of the electronic apparatus and defines a virtual plane. The optical unit set includes a plurality of optical units, and each of the optical units includes a light source and an image capturing device. The light source emits a detecting light towards the virtual plane, and the virtual plane extends from the surface towards a direction away from the surface. The image capturing device captures an image along the virtual plane. When an object intersects the virtual plane, the object reflects the detecting light transmitted in the virtual plane into a reflected light. The image capturing device detects the reflected light to obtain information of the object.

According to an embodiment of the invention, an electronic system having a gesture input function is provided, which includes the electronic apparatus and the gesture sensing apparatus.

According to an embodiment of the invention, a gesture determining method is provided, which includes the following. At a first time, a first section information and a second section information of an object are respectively obtained at a first sampling place and a second sampling place. At a second time, a third section information and a fourth section information of the object are respectively obtained at the first sampling place and the second sampling place. The first section information and the third section information are compared to obtain a first variation information. The second section information and the fourth section information are compared to obtain a second variation information. A gesture change of the object is determined according to the first variation information and the second variation information.

Based on the above, the gesture sensing apparatus and the electronic system having gesture input function in the embodiment of the invention utilize the optical unit set to define the virtual plane and detect the light reflected by the object that intersects the virtual plane. Accordingly, the embodiment of the invention uses a simple configuration to achieve spatial gesture sensing. Therefore, the gesture sensing apparatus in the embodiment of the invention achieves efficient gesture sensing with low costs. In addition, according to the embodiment of the invention, the gesture change is determined based on the variation of the section information of the object, and thus the gesture determining method in the embodiment of the invention is simpler and achieves favorable gesture determining effect.

In order to make the aforementioned features and advantages of the invention more comprehensible, exemplary embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic bottom view of an electronic system having a gesture input function according to an embodiment of the invention.

FIG. 1B is a schematic perspective view of the electronic system having gesture input function shown in FIG. 1A.

FIG. 1C is a schematic perspective view of the optical unit shown in FIG. 1A.

FIG. 1D is a schematic side view illustrating an alteration of the optical unit shown in FIG. 1C.

FIG. 2 is a block diagram of the gesture sensing apparatus shown in FIG. 1A.

FIG. 3A is a schematic perspective view that depicts using the gesture sensing apparatus shown in FIG. 1B to sense an object.

FIG. 3B is a schematic top view that depicts using the gesture sensing apparatus shown in FIG. 1B to sense the object.

FIG. 4A illustrates an image captured by an image capturing device 212a shown in FIG. 1B.

FIG. 4B illustrates an image captured by an image capturing device 212b shown in FIG. 1B.

FIG. 5 is a schematic perspective view of an electronic system having a gesture input function according to another embodiment of the invention.

FIG. 6A is a schematic perspective view of an electronic system having a gesture input function according to yet another embodiment of the invention.

FIG. 6B is a flowchart illustrating a gesture determining method according to an embodiment of the invention.

FIG. 7A is a schematic perspective view illustrating a relationship between a virtual plane and an object in FIG. 6A.

FIG. 7B is a schematic side view of FIG. 7A.

FIG. 7C provides schematic views of sections of the object of FIG. 7A in three virtual planes.

FIG. 8 illustrates movements of the sections of a gesture in three virtual planes in front of a screen of the electronic system having gesture input function in FIG. 6A.

FIGS. 9A, 9B, and 9C respectively illustrate three gesture changes in front of the screen of the electronic system having gesture input function in FIG. 6A.

FIG. 10 illustrates a process of gesture sensing and recognition of the gesture sensing apparatus of FIG. 6A.

### DESCRIPTION OF EMBODIMENTS

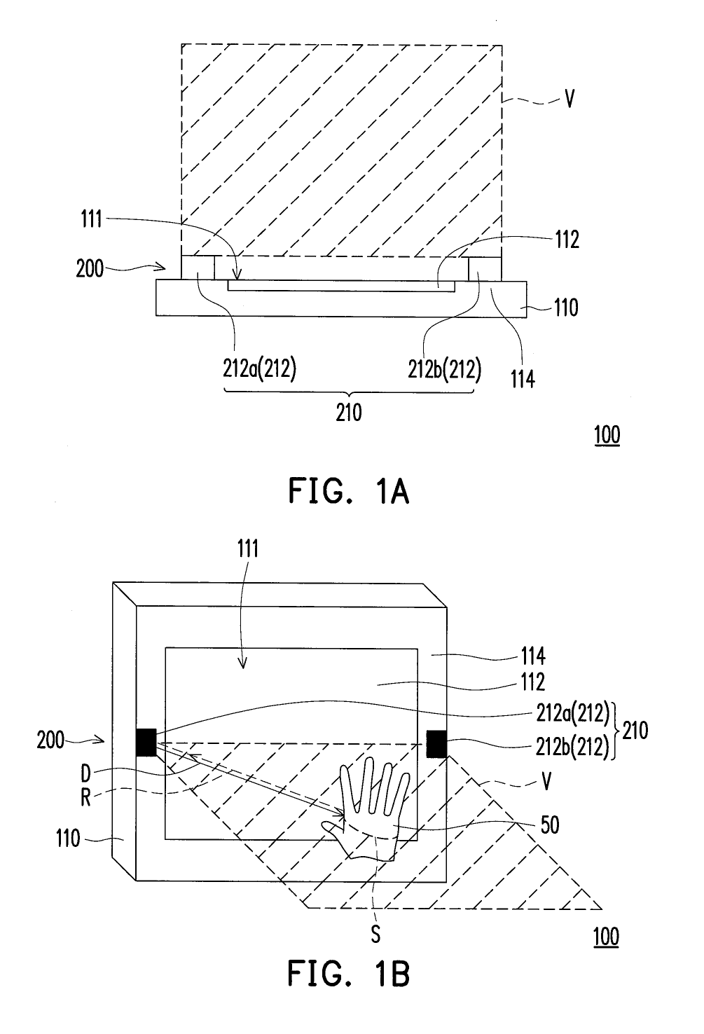

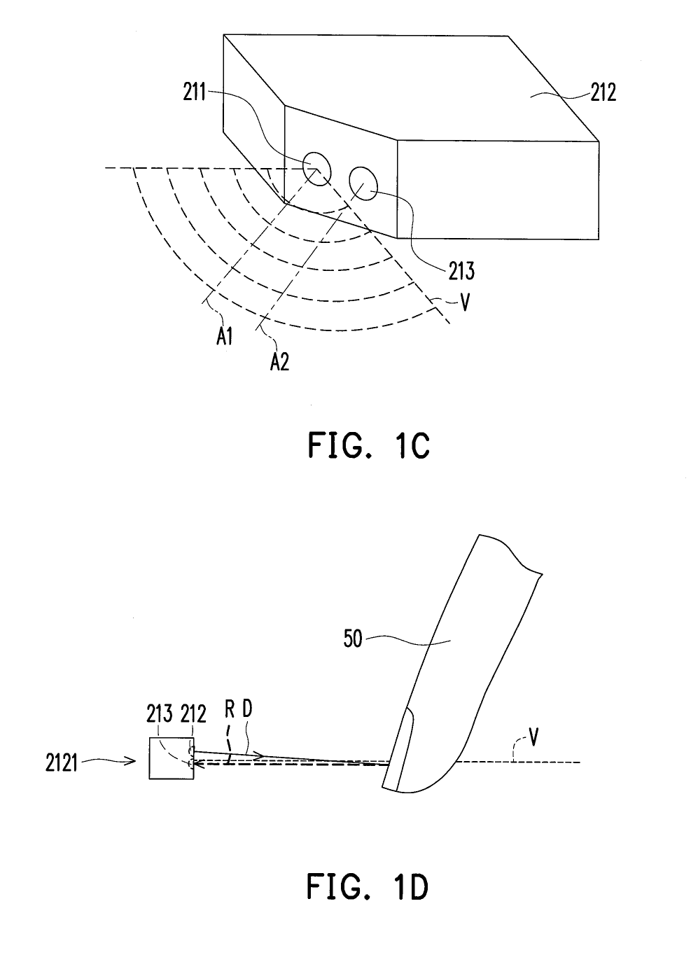

FIG. 1A is a schematic bottom view of an electronic system having gesture input function according to an embodiment of the invention. FIG. 1B is a schematic perspective view of the electronic system having a gesture input function, as shown in FIG. 1A. FIG. 1C is a schematic perspective view of the optical unit shown in FIG. 1A. With reference to FIGS. 1A˜1C, in this embodiment, an electronic system 100 having a gesture input function includes an electronic apparatus 110 and a gesture sensing apparatus 200. In this embodiment, the electronic apparatus 110 is a tablet computer, for example. However, in other embodiments, the electronic apparatus 110 is a display, a personal digital assistant (PDA), a mobile phone, a digital camera, a digital video camera, a laptop computer, an all-in-one computer, or other suitable electronic apparatuses. In this embodiment, the electronic apparatus 110 has a surface 111, and the surface 111 is a display surface of the electronic apparatus 110, i.e. the display surface 111 of a screen 112 of the electronic apparatus 110. However, in other embodiments, the surface 111 is a keyboard surface, a user interface surface, or any other suitable surface.

The gesture sensing apparatus 200 is configured to be disposed on the electronic apparatus 110. The gesture sensing apparatus 200 includes at least an optical unit set 210, which is disposed beside the surface 111 of the electronic apparatus 110 and defines a virtual plane V (one optical unit set 210 is depicted in FIGS. 1A and 1B as an example). In this embodiment, the optical unit set 210 is disposed on a frame 114 beside the surface 111 (i.e. the display surface). Each optical unit set 210 includes a plurality of optical units 212 and each of the optical units 212 includes a light source 211 and an image capturing device 213 (two optical units 212 are illustrated in FIGS. 1A and 1B as an example). In this embodiment, the light source 211 is a laser generator, such as a laser diode. However, in other embodiments, the light source 211 is a light emitting diode or any other suitable light emitting element.

The light source 211 emits a detecting light D towards the virtual plane V, and the virtual plane V extends from the surface 111 towards a direction away from the surface 111. In this embodiment, the light source 211, for example, emits the detecting light D along the virtual plane V. Moreover, in this embodiment, the detecting light D is an invisible light, such as an infrared light. However, in some other embodiments, the detecting light D is a visible light. In addition, in this embodiment, the virtual plane V is substantially perpendicular to the surface 111. However, in some other embodiments, the virtual plane V and the surface 111 form an included angle that is not equal to 90 degrees, but the virtual plane V and the surface 111 are not parallel to each other.

The image capturing device 213 captures an image along the virtual plane V, so as to detect an object in the virtual plane V. In this embodiment, the image capturing device 213 is a line sensor. In other words, the detected plane is linear. For instance, the image capturing device 213 is a complementary metal oxide semiconductor sensor (CMOS sensor) or a charge coupled device (CCD).

When an object 50 (a hand of the user or other suitable objects) intersects the virtual plane V, the object 50 reflects the detecting light D transmitted in the virtual plane V into a reflected light R, and the image capturing device 213 detects the reflected light R so as to obtain information of the object 50, such as position information, size information, etc. of the object 50.

In this embodiment, an optical axis A1 of the light sources 211 and an optical axis A2 of the image capturing devices 213 of the optical units 212a and 212b of the optical unit set 210 are substantially in the virtual plane V, so as to ensure that the detecting light D is transmitted in the virtual plane V and further to ensure that the image capturing device 213 captures the image along the virtual plane V, that is, to detect the reflected light R transmitted in the virtual plane V.

Regarding the aforementioned “the light source 211 emits a detecting light D along the corresponding virtual plane V” and the description “optical axis A1 of the light sources 211 of the optical units 212a and 212b are substantially in the virtual plane V”, the described direction of the light source 211 is one of the embodiments of the invention. For example, in another embodiment as shown in FIG. 1D, the light source 211 of the optical unit 2121 is disposed above the corresponding virtual plane V and emits the detecting light D obliquely downward. That is, the optical axis of the light source 211 intersects the virtual plane V (in FIG. 1D, the solid line that represents the detecting light D coincides with the optical axis of the light source 211, for example). Herein, the reflected light R is still generated when the detecting light D reaches the object 50, and the reflected light R can still be detected by the image capturing device 213 of the corresponding optical unit 2121. The foregoing can still be achieved when the light source 211 is disposed below the virtual plane V. Thus, it is known from the above that the aforementioned embodiments of the invention can be achieved as long as the light source 211 emits the detecting light D towards the corresponding virtual plane V.

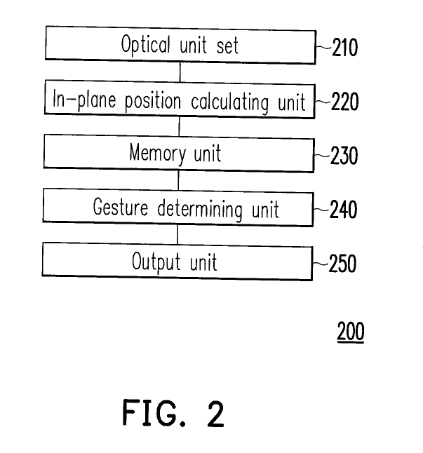

FIG. 2 is a block diagram of the gesture sensing apparatus shown in FIG. 1A.

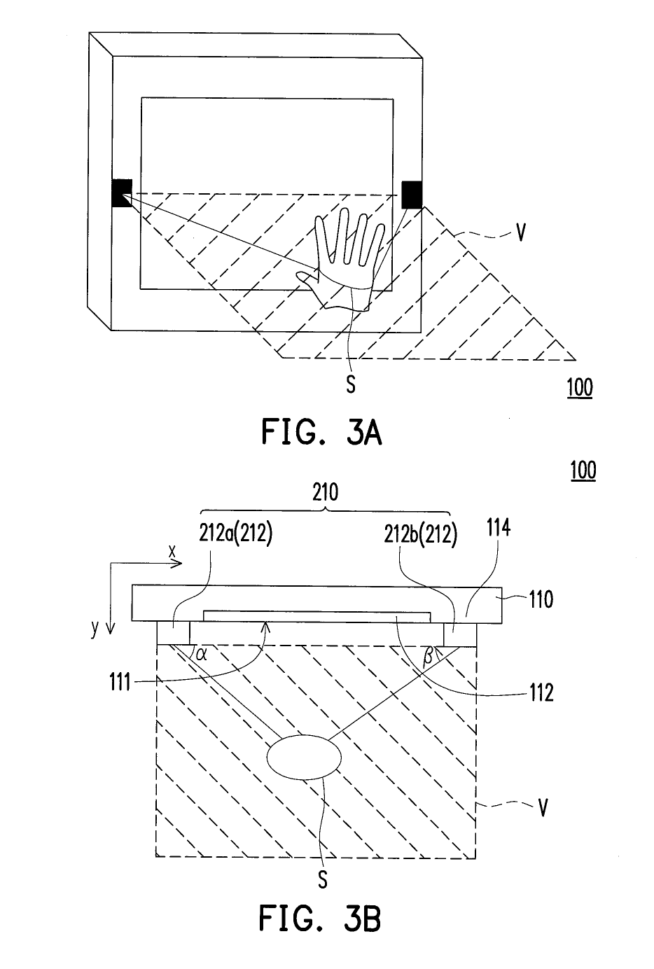

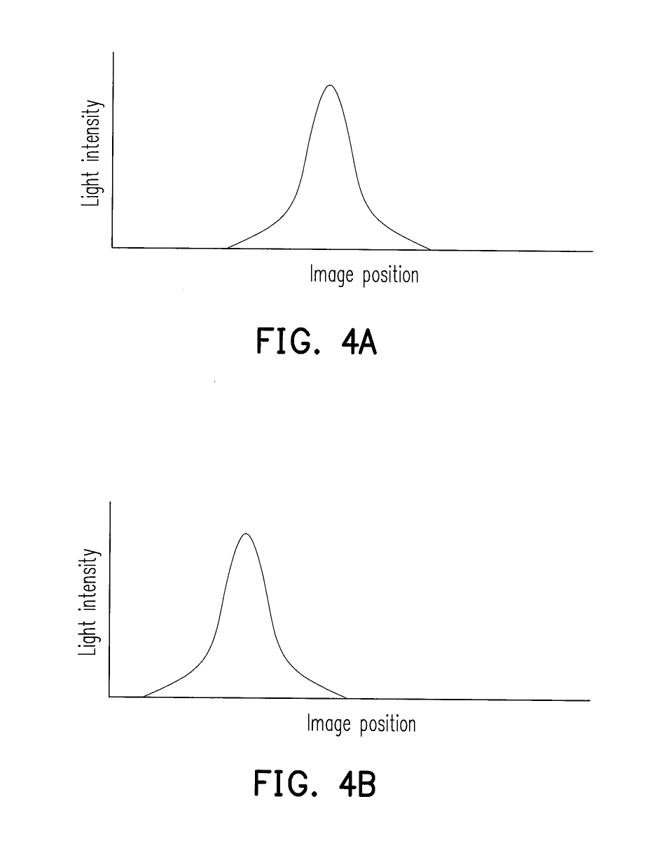

FIG. 3A is a schematic perspective view that depicts using the gesture sensing apparatus shown in FIG. 1B to sense an object. FIG. 3B is a schematic top view that depicts using the gesture sensing apparatus shown in FIG. 1B to sense the object. FIG. 4A illustrates an image captured by the image capturing device of the optical unit 212a shown in FIG. 1B, and FIG. 4B illustrates an image captured by the image capturing device of the optical unit 212b shown in FIG. 1B. Referring to FIGS. 2, 3A, and 3B, in this embodiment, the gesture sensing apparatus 200 further includes an in-plane position calculating unit 220. The in-plane position calculating unit 220 calculates the position and size of a section S of the object 50 in the virtual plane V by a triangulation method according to the information of the object 50 obtained by the image capturing devices 213 (the image capturing devices 213 of the optical units 212a and 212b, for example). As illustrated in FIGS. 3A and 3B, an included angle α, formed by the display surface 111 and a line connecting the section S and the image capturing device 213 of the optical unit 212a, and an included angle β, formed by the display surface 111 and a line connecting the section S and the image capturing device 213 of the optical unit 212b, are determined by the position and size of the section S of the image captured by the image capturing devices 213 of the optical units 212a and 212b, which also determine opening angles that all points of the section S forms with respect to the image capturing devices 213 of the optical units 212a and 212b. Referring to FIGS. 4A and 4B, the vertical axis represents the light intensity detected by the image capturing device 213, and the horizontal axis represents the position of the image on a sensing plane of the image capturing device 213. The image positions in the horizontal axis can all be converted into incident angles that light enters the image capturing device 213, i.e. the incident angle of the reflected light R. Therefore, the opening angle formed by the section S and the included angles α and β is obtained according to the position of the section S obtained by the image capturing devices 213 of the optical units 212a and 212b. Then, the in-plane position calculating unit 220 calculates the position of the section S of the object 50 in the virtual plane V by a triangulation method according to the included angles α and β, and calculates the size of the section S based on the opening angles formed by all points of the section S with respect to the image capturing devices 213 of the optical units 212a and 212b.

In this embodiment, the gesture sensing apparatus 200 further includes a memory unit 230, which stores the position and size of the section S of the object 50 calculated by the in-plane position calculating unit 220. In this embodiment, the gesture sensing apparatus 200 further includes a gesture determining unit 240, which determines a gesture generated by the object 50 according to the position and size of the section S of the object 50 stored in the memory unit 230. More specifically, the memory unit 230 stores a plurality of positions and sizes of the section S at different times for the gesture determining unit 240 to determine the movement of the section S and further determine the movement of the gesture. In this embodiment, the gesture determining unit 240 determines the movement of the gesture of the object 50 according to a time-varying variation of the position and a time-varying variation of the size of the section S of the object 50 stored in the memory unit 230.

In this embodiment, the gesture sensing apparatus 200 further includes a transmission unit 250, which transmits a command corresponding to the gesture determined by the gesture determining unit 240 to a circuit unit for receiving the command. For example, if the electronic apparatus 100 is a tablet computer, an all-in-one computer, a personal digital assistant (PDA), a mobile phone, a digital camera, a digital video camera, or a laptop computer, the circuit unit for receiving the command is a central processing unit (CPU) in the electronic apparatus 100. In addition, if the electronic apparatus 100 is a display screen, the circuit unit for receiving the command is a computer electrically connected to the display screen or a central processing unit or control unit of a suitable host.

Take FIG. 1B as an example, when the gesture determining unit 240 determines that the object 50 moves from a left front side of the screen 112 to a right front side of the screen 112, the gesture determining unit 240, for instance, gives a command of turning to a left page and transmits the command to the circuit unit for receiving the command via the transmission unit 250, so as to allow the circuit unit to control the screen 112 to display the image of the left page. Similarly, when the gesture determining unit 240 determines that the object 50 moves from the right front side of the screen 112 to the left front side of the screen 112, the gesture determining unit 240, for instance, gives a command of turning to a right page and transmits the command to the circuit unit for receiving the command via the transmission unit 250, so as to allow the circuit unit to control the screen 112 to display the image of the right page. Specifically, when the gesture determining unit 240 detects the continuous increase of an x coordinate of the position of the object 50 and the increase reaches a threshold value, the gesture determining unit 240 determines that the object 50 is moving to the right. When the gesture determining unit 240 detects the continuous decrease of the x coordinate of the position of the object 50 and the decrease reaches a threshold value, the gesture determining unit 240 determines that the object 50 is moving to the left.

In this embodiment, the virtual plane V extends from the surface 111 towards a direction away from the surface 111. For example, the virtual plane V is substantially perpendicular to the surface 111. Therefore, the gesture sensing apparatus 200 not only detects the upward, downward, leftward, and rightward movements of the objects in front of the screen 112 but also detects a distance between the object 50 and the screen 112, that is, a depth of the object 50. For instance, the text or figure on the screen 112 is reduced in size when the object 50 moves close to the screen 112; and the text or figure on the screen 112 is enlarged when the object 50 moves away from the screen 112. In addition, other gestures may indicate other commands, or the aforementioned gestures can be used to indicate other commands. To be more specific, when the gesture determining unit 240 detects the continuous increase of a y coordinate of the position of the object 50 and the increase reaches a threshold value, the gesture determining unit 240 determines that the object 50 is moving in a direction away from the screen 112. On the contrary, when the gesture determining unit 240 detects continuous decrease of the y coordinate of the position of the object 50 and the decrease reaches a threshold value, the gesture determining unit 240 determines that the object 50 is moving in a direction towards the screen 112.

The gesture sensing apparatus 200 and the electronic system 100 having the gesture input function in the embodiment of the invention utilize the optical unit set 210 to define the virtual plane V and detect the light (i.e. the reflected light R) reflected by the object 50 that intersects the virtual plane V. Therefore, the embodiment of the invention achieves spatial gesture sensing by a simple configuration. Compared with the conventional technique which uses an expensive three-dimensional camera and a processor that processes three-dimensional images to sense the gesture spatially, the gesture sensing apparatus 200 disclosed in the embodiments of the invention has a simpler configuration and achieves efficient gesture sensing with low costs.

Moreover, the gesture sensing apparatus 200 of this embodiment has a small, thin, and light structure. Therefore, the gesture sensing apparatus 200 is easily embedded in the electronic apparatus 110 (such as tablet computer or laptop computer). In addition, the gesture sensing apparatus 200 and the electronic system 100 having the gesture input function disclosed in the embodiment of the invention sense the position and size of the area the object 50 intersects the virtual plane V (i.e. the section S). Thus, the calculation process is simpler and a frame rate of the gesture sensing apparatus 200 is improved to predict the gesture of the object 50 (gesture of the palm, for example).

When using the gesture sensing apparatus 200 and the electronic system 100 having the gesture input function disclosed in the embodiment of the invention, the user can input by gesture without touching the screen 112. Therefore, the applicability of the gesture sensing apparatus 200 and the electronic system 100 having the gesture input function is greatly increased. For example, when a housewife is cooking, she can wave her hand before the screen 112 to turn the pages of the recipe displayed on the screen 112. She does not need to touch the screen 112 with greasy hands, which may grease the surface of the screen 112. In addition, when a surgeon is wearing sterile gloves and performing an operation, the surgeon can wave his/her hand before the screen 112 to look up image data of a patient and prevent contaminating the gloves. When a mechanist is repairing a machine, the mechanist can wave his/her hand before the screen 112 to look up the maintenance manual without touching the screen with his/her dirty hands. Moreover, when the user is watching television in the bathtub, the user can select channels or adjust volume by hand gesture before the screen 112. Thus, the user does not need to touch the television with wet hands, which may cause bad effects to the television. Commands, such as displaying recipe, checking patient's data or technical manual, selecting channels, adjusting volume, etc., can be easily performed by simple uncomplicated hand gesture. Therefore, the aforementioned can be achieved by the gesture sensing apparatus 200 that has a simple configuration in this embodiment. Since expensive three-dimensional cameras and processors or software for reading three-dimensional images are not required, the costs are effectively reduced.

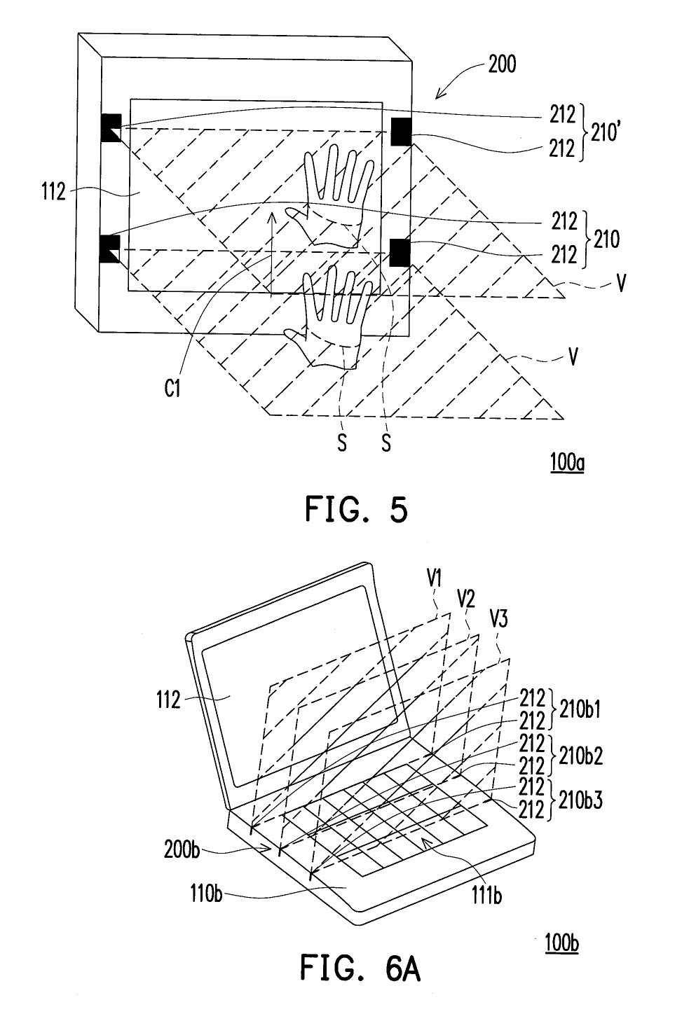

FIG. 5 is a schematic perspective view of an electronic system having a gesture input function according to another embodiment of the invention. Referring to FIG. 5, an electronic system 100a having a gesture input function in this embodiment is similar to the electronic system 100 having the gesture input function as depicted in FIG. 1B, and the difference between these two electronic systems is described below. In this embodiment, the electronic system 100a having the gesture input function includes a gesture sensing apparatus 200a, which has a plurality of optical unit sets 210′ and 210″. Two optical unit sets 210′ and 210″ are illustrated in FIG. 5 as an example. However, it is noted that, in some other embodiments, the gesture sensing apparatus includes three or more optical unit sets. Accordingly, a plurality of the virtual planes V is generated. In this embodiment, the virtual planes V respectively defined by the optical unit sets 210′ and 210″ are substantially parallel to each other.

In this embodiment, the virtual planes V are arranged substantially from top to bottom along the screen 112, and each of the virtual planes V extends substantially from left to right along the screen 112. Therefore, the gesture sensing apparatus 200a not only detects the leftward/rightward and forward/backward movements (that is, movements in the depth direction) of the object 50 but also detects the upward/downward movements of the object 50 with respect to the screen 112. For instance, when the object 50 moves upward in a direction C1, the object 50 sequentially intersects the lower virtual plane V and the upper virtual plane V of FIG. 5, and is sequentially detected by the optical unit set 210″ and the optical unit set 210′. Accordingly, the gesture determining unit 240 of the gesture sensing apparatus 200a determines that the object 50 is moving upward.

In this embodiment, the optical axes A1 of the light sources 211 and the optical axes A2 of the image capturing devices 213 of the optical units 212 of the optical unit set 210 are substantially in the lower virtual plane V of FIG. 5, and the optical axes A1 of the light sources 211 and the optical axes A2 of the image capturing devices 213 of the optical units 212 of the optical unit set 210′ are substantially in the upper virtual plane V of FIG. 5.

In another embodiment, the virtual planes V are arranged substantially from left to right along the screen 112, and each of the virtual planes V substantially extends from top to bottom along the screen 112. In addition, in other embodiments, the virtual planes V are arranged and extend in other directions with respect to the screen 112.

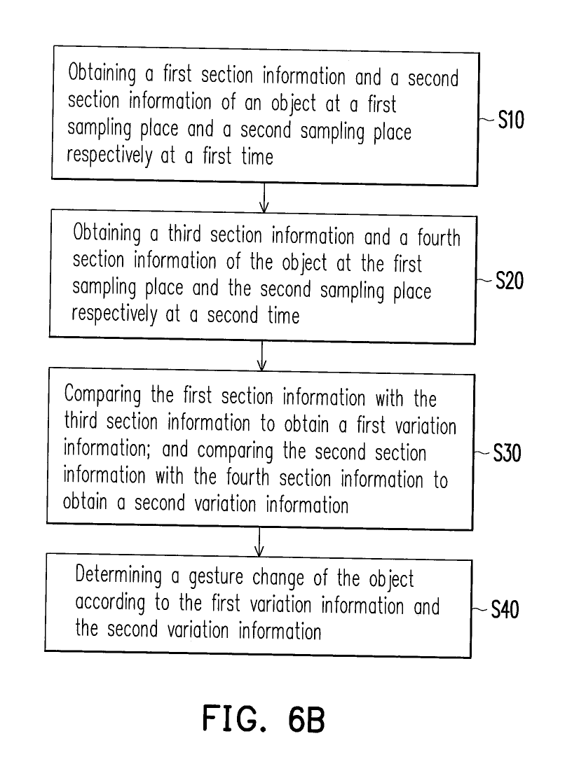

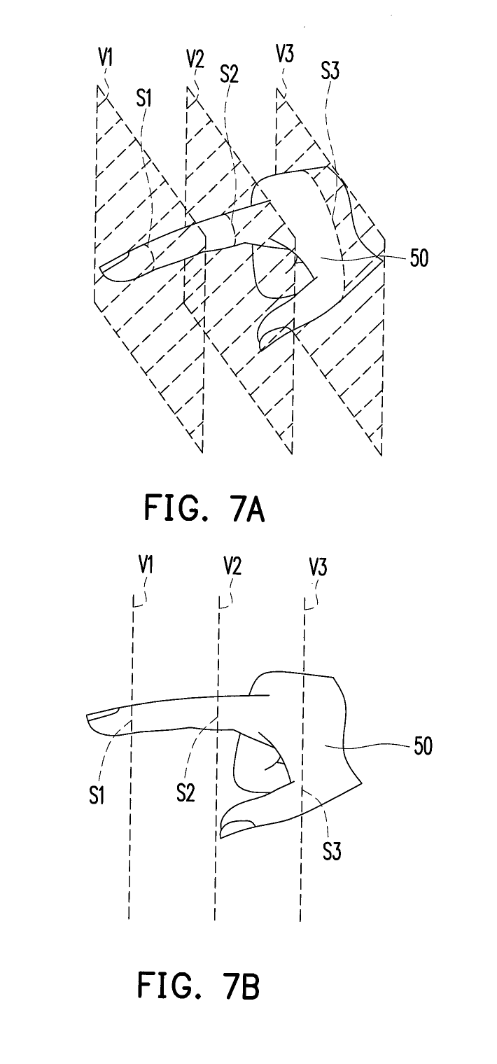

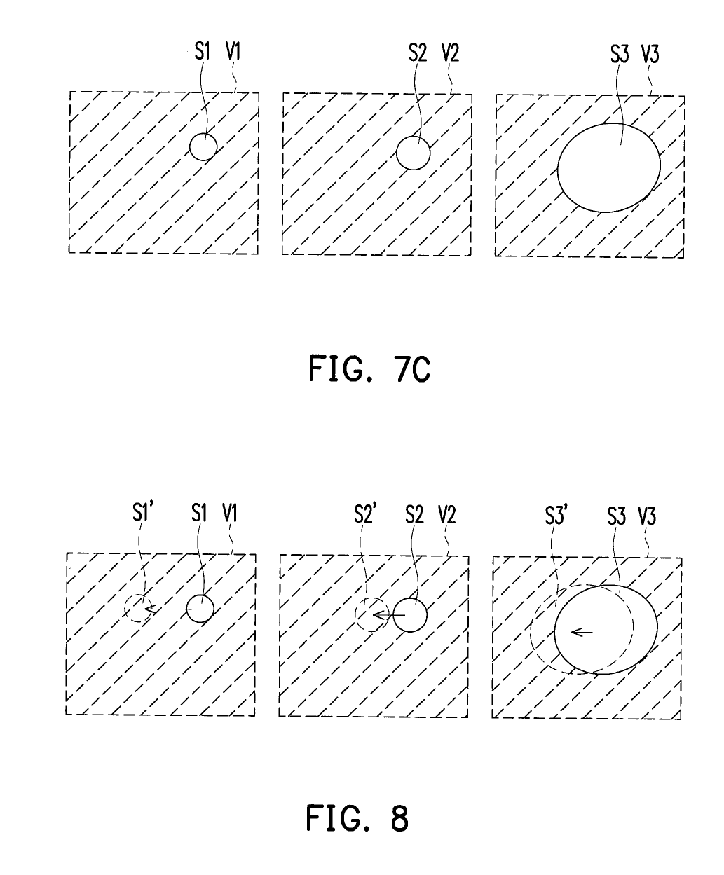

FIG. 6A is a schematic perspective view of an electronic system having a gesture input function according to yet another embodiment of the invention. FIG. 6B is a flowchart illustrating a gesture determining method according to an embodiment of the invention. FIG. 7A is a schematic perspective view illustrating a relationship between a virtual plane and an object in FIG. 6A. FIG. 7B is a schematic side view of FIG. 7A. FIG. 7C provides schematic views of sections of the object of FIG. 7A in three virtual planes. Referring to FIGS. 6A˜6B and 7A˜7C, an electronic system 100b having a gesture input function in this embodiment is similar to the electronic system 100a having the gesture input function as illustrated in FIG. 5, and the difference between these two electronic systems is described below. In this embodiment, the electronic system 100b having the gesture input function includes an electronic apparatus 110b, which is a laptop computer, for example. A surface 111b of the electronic apparatus 110b is a keyboard surface, for example. In this embodiment, the gesture sensing apparatus 200b includes a plurality of optical unit sets 210b1, 210b2, and 210b3 (three optical unit sets are illustrated in FIG. 6A as an example) for generating three virtual planes V1, V2, and V3 respectively. The virtual planes V1, V2, and V3 are substantially perpendicular to the surface 111b and are substantially parallel to each other.

In this embodiment, the screen 112 of the electronic apparatus 110b is located at a side of the virtual planes V1, V2, and V3. For example, the screen 112 can be turned to a position to be substantially parallel to the virtual planes V1, V2, and V3, or turned to an angle that is less inclined relative to the virtual planes V1, V2, and V3. Thereby, the gesture sensing apparatus 200b detects the gesture before the screen 112. In an embodiment, the screen 112 is configured to display a three-dimensional image, and the three-dimensional image intersects the virtual planes V1, V2, and V3 spatially. Accordingly, after the gesture determining unit 240 integrates the position coordinates of the virtual planes V1, V2, and V3 with the position coordinates of the three-dimensional image displayed by the screen 112 or verifies the conversion relationship therebetween, the gesture in front of the screen 112 can interact with an three-dimensional object of the three-dimensional image spatially before the screen 112.

As illustrated in FIGS. 7A˜7C, different parts of the hand respectively form sections S1, S2, and S3 which have different sizes in the virtual planes V1, V2, and V3. The gesture determining unit 240 determines which parts of the hand correspond to the sections S1, S2, and S3 based on the relationship between sizes of the sections S1, S2, and S3, so as to recognize various gestures. For instance, the section S1 that has a smaller size is recognized as corresponding to a finger of the user, and the section S3 that has a larger size is recognized as corresponding to a palm of the user.

FIG. 8 illustrates movements of the sections of the gesture in three virtual planes in front of the screen of the electronic system having the gesture input function in FIG. 6A. With reference to FIGS. 6A˜6B and 8, a gesture determining method of this embodiment is applicable to the electronic system 100b having the gesture input function illustrated in FIG. 6A or other electronic systems having the gesture input function described in the aforementioned embodiments. The following paragraphs explain the gesture determining method that is applied to the electronic system 100b having the gesture input function in FIG. 6A as an example. The gesture determining method of this embodiment includes the following steps. First, Step S10 is performed to obtain a first section information (information of the section S1, for example) and a second section information (information of the section S3, for example) of the object 50 respectively at a first sampling place and a second sampling place at a first time. In this embodiment, information of the section S1, information of the section S2, and information of the section S3 of the object 50 are respectively obtained at the first sampling place, the second sampling place, and a third sampling place at the first time, wherein the first sampling place, the second sampling place, and the third sampling place respectively refer to the positions of the virtual planes V1, V3, and V2. The sections S1, S2, and S3 are in the virtual planes V1, V2, and V3 respectively. However, it is noted that the number of the sampling places and section information is not limited to the above, and the number can be two, three, four, or more.

Next, Step S20 is performed to obtain a third section information (information of section SF, for example) and a fourth section information (information of section S3′, for example) of the object 50 respectively at the first sampling place and the second sampling place at a second time. In this embodiment, information of the section S1′, information of a section S2′, and information of the section S3′ of the object 50 are respectively obtained in the virtual planes V1, V2, and V3 at the second time. The sections S1′, S2′, and S3′ are in the virtual planes V1, V2, and V3 respectively. In this embodiment, information of the sections S1˜S3 and S1′˜S3′ each includes at least one of a section position, a section size, and the number of sections.

Then, Step S30 is performed to compare the first section information (information of the section S1, for example) and the third section information (information of the section S1′) to obtain a first variation information. The second section information (information of the section S3, for example) and the fourth section information (information of the section S3′) are compared to obtain a second variation information. In this embodiment, information of the section S2 and information of the section S2′ are further compared to obtain a third variation information. In this embodiment, the first variation information, the second variation information, and the third variation information each include at least one of the displacement of the section, the rotation amount of the section, the variation of section size, and the variation of the number of the sections.

Thereafter, Step S40 is performed to determine a gesture change of the object according to the first variation information and the second variation information. In this embodiment, the gesture change of the object is determined according to the first variation information, the second variation information, and the third variation information. The gesture of this embodiment refers to various gestures of the hand of the user or various changes of the position, shape, and rotating angle of a touch object (such as a stylus).

For example, referring to FIGS. 6A and 8, FIG. 8 illustrates that the sections S1, S2, and S3 respectively move leftward to the positions of the sections S1′, S2′, and S3′ in the virtual planes V1, V2, and V3. A distance that the section S1 moves is larger than a distance that the section S2 moves, and the distance that the section S2 moves is larger than a distance that the section S3 moves. The section S1 corresponds to the finger, and the section S3 corresponds to the palm. Accordingly, the gesture determining unit 240 determines that the wrist remains substantially still while the finger moves from the right of the screen 112 to the left with the wrist as an axle center. The above explains how to determine the gesture change based on the displacement of the sections.

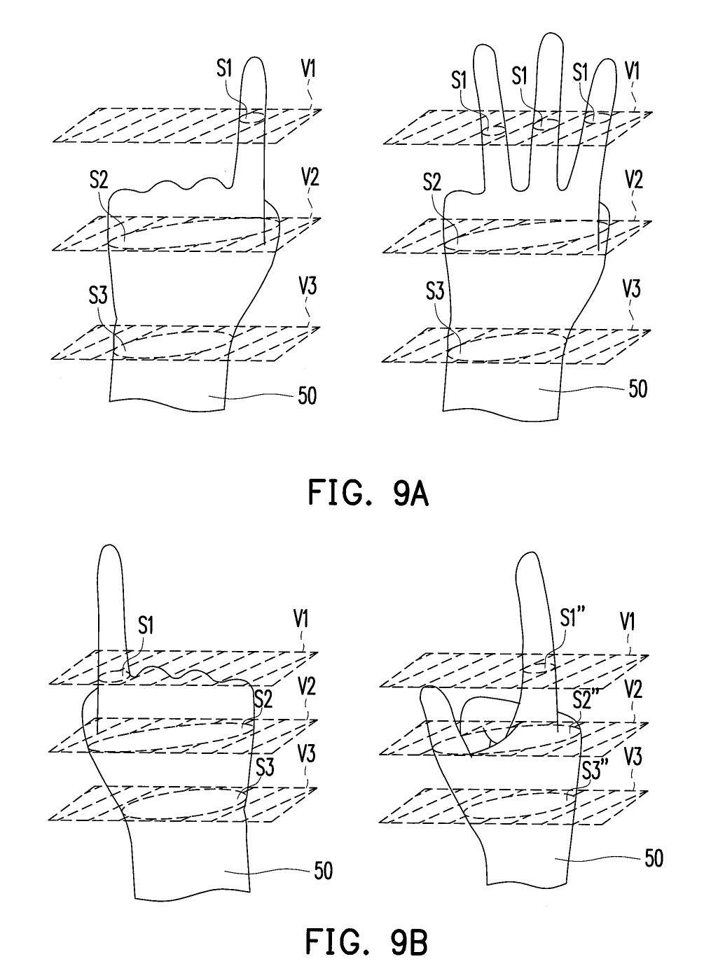

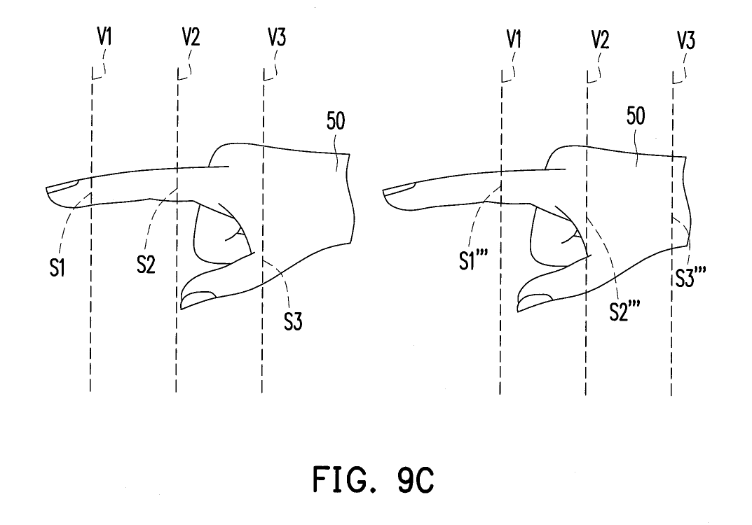

FIGS. 9A, 9B, and 9C respectively illustrate three gesture changes in front of the screen of the electronic system having the gesture input function in FIG. 6A. First, referring to FIGS. 6A and 9A, when the gesture of the user changes from the left figure of FIG. 9A to the right figure of FIG. 9A, i.e. changes from “stretching out one finger” to “stretching out three fingers,” the gesture sensing apparatus 200b detects that the number of the sections S1 changes from one to three, and accordingly, the gesture determining unit 240 determines that the gesture of the user changes from “stretching out one finger” to “stretching out three fingers.” The above explains how to determine the gesture change based on variation of the number of the sections. Further, referring to FIGS. 6A and 9B, when the gesture of the user changes from the left figure of FIG. 9B to the right figure of FIG. 9B, the gesture sensing apparatus 200b detects that the sections S1, S2, and S3 in the virtual planes V1, V2, and V3 are rotated to the positions of the sections S1″, S2″, and S3″, as shown in the right figure of FIG. 9B, and accordingly, the gesture determining unit 240 determines that the hand of the user is rotated. The above explains how to determine the gesture change based on the rotation amount of the sections. Furthermore, referring to FIGS. 6A and 9C, when the gesture of the user changes from the left figure of FIG. 9C to the right figure of FIG. 9C, the gesture sensing apparatus 200b detects that the sizes of the sections S1, S2, and S3 in the virtual planes V1, V2, and V3 are changed to the sizes of the sections S1″′, S2′″, and S3′″, as shown in the right figure of FIG. 9C. For example, the size of the section S2′″ is apparently larger than the size of the section S2. Accordingly, the gesture determining unit 240 determines that the hand of the user is moving toward to the screen 112. The above explains how to determine the gesture change based on variation of the sizes of the sections.

FIGS. 8 and 9A˜9C illustrate four different types of gesture changes as examples. However, it is noted that the electronic system 100b having the gesture input function and the gesture determining unit 240 of FIG. 6A are able to detect more different gestures based on principles as described above, which all fall within the scope of the invention, and thus detailed descriptions are not repeated hereinafter. The above discloses determining gesture change between the first time and the second time, but it is merely one of the examples. The gesture determining method of this embodiment is also applicable in comparing the section information of every two sequential times among a plurality of times (three or more times, for example) to obtain variation information for determining continuous gesture change.

According to this embodiment, the gesture change is determined based on the variation of the section information of the object 50, and thus the gesture determining method of this embodiment is simpler and achieves favorable gesture determining effect. Therefore, an algorithm for performing the gesture determining method is simplified to reduce the costs for software development and hardware production.

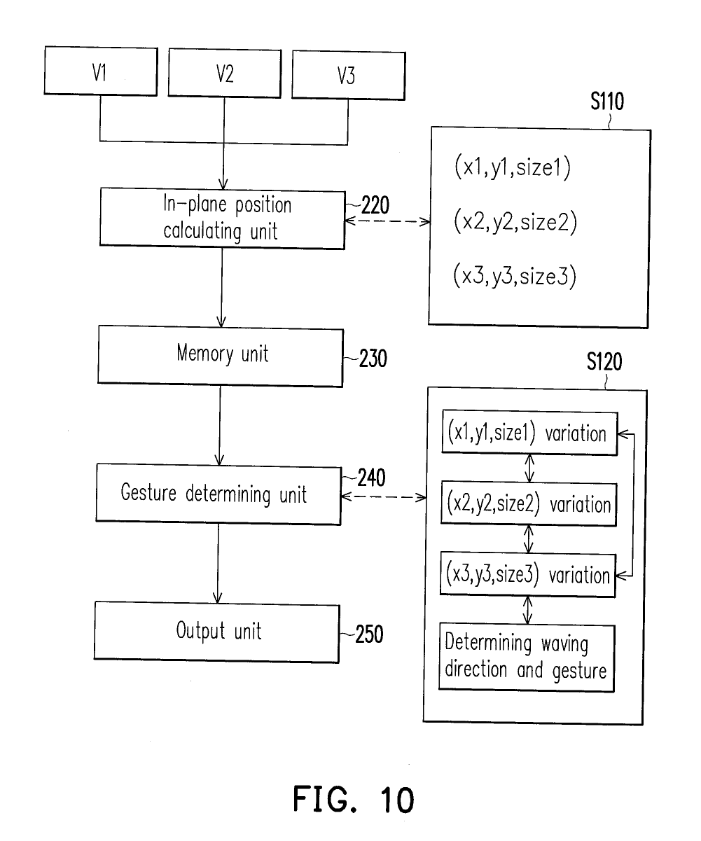

FIG. 10 illustrates a process of gesture sensing and recognition of the gesture sensing apparatus of FIG. 6A. With reference to FIGS. 6A and 10, first, optical unit sets 210b1, 210b2, and 210b3 respectively sense the sections S1, S2, and S3 in the virtual planes V1, V2, and V3. Then, the in-plane position calculating unit 220 carries out Step S110 to respectively decide the coordinates and size parameter (x1, y1, size1) of the section 51, the coordinates and size parameter (x2, y2, size2) of the section S2, and the coordinates and size parameter (x3, y3, size3) of the section S3 by a triangulation method. Therefore, Steps S10 and S20 of FIG. 6B are completed by the optical unit set 210 and the in-plane position calculating unit 220. Thereafter, the memory unit 230 stores the coordinates and size parameters of the sections S1, S2, and S3 that are decided by the in-plane position calculating unit 220 at different times. Following that, the gesture determining unit 240 performs Step S120 to determine the gesture and a waving direction thereof according to the variation of the parameter (x1, y1, size1), parameter (x2, y2, size2), and parameter (x3, y3, size3) in continuous different times. Accordingly, Steps S30 and S40 of FIG. 6B are completed by the memory unit 230 and the gesture determining unit 240. Then, the transmission unit 250 transmits a command corresponding to the gesture determined by the gesture determining unit 240 to a circuit unit for receiving the command.

The gesture sensing and recognition process of FIG. 10 is applicable not only to the embodiment of FIG. 6A but also to the embodiment of FIG. 5 or other embodiments. In one embodiment, the screen 112 of FIG. 5 is also configured to display a three-dimensional image, and the user's hand can interact with the three-dimensional object in the three-dimensional image spatially.

To conclude the above, the gesture sensing apparatus and the electronic system having the gesture input function in the embodiment of the invention utilize the optical unit set to define the virtual plane and detect the light reflected by the object that intersects the virtual plane. Accordingly, the embodiment of the invention uses a simple configuration to achieve spatial gesture sensing. Therefore, the gesture sensing apparatus of the embodiment of the invention achieves efficient gesture sensing with low costs. In addition, the gesture determining method of the embodiment of the invention determines the gesture change based on variation of the section information of the object, and thus the gesture determining method of the embodiment of the invention is simpler and achieves favorable gesture determining effect.

Although the invention has been described with reference to the above embodiments, it will be apparent to one of ordinary skill in the art that modifications to the described embodiments may be made without departing from the spirit of the invention. Therefore, the scope of the invention falls in the appended claims.

What is claimed is:

1. A gesture sensing apparatus configured to be disposed on an electronic apparatus, the gesture sensing apparatus comprising:
at least one optical unit set, disposed beside a surface of the electronic apparatus and defining a virtual plane, each of the optical unit sets comprising a plurality of optical units, each of the optical units comprising:
a light source emitting a detecting light towards the virtual plane, wherein the virtual plane extends from the surface towards a direction away from the surface; and
an image capturing device capturing an image along the virtual plane, wherein when an object intersects the virtual plane, the object reflects the detecting light transmitted in the virtual plane into a reflected light, and the image capturing device detects the reflected light to obtain information of the object.

2. The gesture sensing apparatus of claim 1, wherein the surface is a display surface, a keyboard surface, or a surface of a user interface.

3. The gesture sensing apparatus of claim 1, wherein the virtual plane is substantially perpendicular to the surface.

4. The gesture sensing apparatus of claim 1, wherein the at least one optical unit set is a plurality of optical unit sets, and the virtual planes respectively defined by the optical unit sets are substantially parallel to each other.

5. The gesture sensing apparatus of claim 1, further comprising an in-plane position calculating unit, which calculates a position and a size of a section of the object in the virtual plane by a triangulation method according to the information of the object obtained by the image capturing devices.

6. The gesture sensing apparatus of claim 5, further comprising a memory unit, which stores the position and the size of the section of the object calculated by the in-plane position calculating unit.

7. The gesture sensing apparatus of claim 6, further comprising a gesture determining unit, which determines a gesture generated by the object according to the position and size of the section of the object stored in the memory unit.

8. The gesture sensing apparatus of claim 7, further comprising a transmission unit, which transmits a command corresponding to the gesture determined by the gesture determining unit to a circuit unit for receiving the command.

9. The gesture sensing apparatus of claim 7, wherein the gesture determining unit determines a movement of the gesture of the object according to time-varying variations of the position and size of the section of the object stored in the memory unit.

10. The gesture sensing apparatus of claim 1, wherein the image capturing device is a line sensor.

11. The gesture sensing apparatus of claim 10, wherein the line sensor is a complementary metal oxide semiconductor sensor or a charge coupled device.

12. The gesture sensing apparatus of claim 1, wherein the light source is a laser generator or a light emitting diode.

13. The gesture sensing apparatus of claim 1, wherein optical axes of the light sources of the optical units and optical axes of the image capturing devices of the optical unit set are substantially in the virtual plane.

14. An electronic system having a gesture input function, the electronic system comprising:
an electronic apparatus having a surface; and
a gesture sensing apparatus disposed on the electronic apparatus, the gesture sensing apparatus comprising:
at least one optical unit set, disposed beside the surface of the electronic apparatus and defining a virtual plane, each of the optical unit sets comprising a plurality of optical units, each of the optical units comprising:
a light source emitting a detecting light towards the virtual plane, wherein the virtual plane extends from the surface towards a direction away from the surface; and
an image capturing device capturing an image along the virtual plane, wherein when an object intersects the virtual plane, the object reflects the detecting light transmitted in the virtual plane into a reflected light, and the image capturing device detects the reflected light to obtain information of the object.

15. The electronic system having the gesture input function of claim 14, wherein the surface is a display surface, a keyboard surface, or a surface of a user interface.

16. The electronic system having the gesture input function of claim 14, wherein the virtual plane is substantially perpendicular to the surface.

17. The electronic system having the gesture input function of claim 14, wherein the at least one optical unit set is a plurality of the optical unit sets, and the virtual planes respectively defined by the optical unit sets are substantially parallel to each other.

18. The electronic system having the gesture input function of claim 14, wherein the gesture sensing apparatus further comprises an in-plane position calculating unit, which calculates a position and a size of a section of the object in the virtual plane by a triangulation method according to the information of the object obtained by the image capturing devices.

19. The electronic system having the gesture input function of claim 18, wherein the gesture sensing apparatus further comprises a memory unit, which stores the position and size of the section of the object calculated by the in-plane position calculating unit.

20. The electronic system having the gesture input function of claim 19, wherein the gesture sensing apparatus further comprises a gesture determining unit, which determines a gesture generated by the object according to the position and size of the section of the object stored in the memory unit.

21. The electronic system having the gesture input function of claim 20, wherein the gesture sensing apparatus further comprises a transmission unit, which transmits a command corresponding to the gesture determined by the gesture determining unit to a circuit unit for receiving the command.

22. The electronic system having the gesture input function of claim 20, wherein the gesture determining unit determines a movement of the gesture of the object according to time-varying variations of the position and size of the section of the object stored in the memory unit.

23. The electronic system having the gesture input function of claim 14, wherein the image capturing device is a line sensor.

24. The electronic system having the gesture input function of claim 23, wherein the line sensor is a complementary metal oxide semiconductor sensor or a charge coupled device.

25. The electronic system having the gesture input function of claim 14, wherein the light source is a laser generator or a light emitting diode.

26. The electronic system having the gesture input function of claim 14, wherein the electronic apparatus comprises a screen that displays a three-dimensional image, and the three-dimensional image intersects the virtual plane spatially.

27. The electronic system having the gesture input function of claim 14, wherein optical axes of the light sources and optical axes of the image capturing devices of the optical units of the optical unit set are substantially in the virtual plane.

28. A gesture determining method, comprising:
obtaining a first section information and a second section information of an object at a first sampling place and a second sampling place respectively at a first time;
obtaining a third section information and a fourth section information of the object at the first sampling place and the second sampling place respectively at a second time;
comparing the first section information and the third section information to obtain a first variation information;
comparing the second section information and the fourth section information to obtain a second variation information; and
determining a gesture change of the object according to the first variation information and the second variation information.

29. The gesture determining method of claim 28, wherein the first sampling place and the second sampling place are spatial positions of a first virtual plane and a second virtual plane, and the first section information and the third section information are information of the sections of the object in the first virtual plane and the second virtual plane.

30. The gesture determining method of claim 29, wherein the first virtual plane is substantially parallel to the second virtual plane.

31. The gesture determining method of claim 28, wherein the first section information, the second section information, the third section information, and the fourth section information each comprise at least one of a position of a section of the object, a size of the section of the object, and number of the section of the object.

32. The gesture determining method of claim 28, wherein the first variation information and the second variation information each comprise at least one of displacement of a section of the object, a rotation amount of the section of the object, variation of a size of the section of the object, and variation of number of the section of the object.
